(19) United States
(12) Patent Application Publication
(10) Pub. No.: US 2026/0118266 A1
(43) Pub. Date: Apr. 30, 2026

(54) DISPLAY PANEL INSPECTION METHOD AND INSPECTION SYSTEM

(71) Applicant: Samsung Display Co., LTD., Yongin-si (KR)

(72) Inventors: DAEHONG KIM, Yongin-si (KR); JEONGMOON LEE, Yongin-si (KR)

(21) Appl. No.: 19/238,691

(22) Filed: Jun. 16, 2025

(30) Foreign Application Priority Data
Oct. 24, 2024 (KR) 10-2024-0146383

(51) Int. Cl. G01N 21/41; G01N 21/958

(52) U.S. Cl. CPC G01N 21/41; G01N 21/958; G01N 2201/068

(57) ABSTRACT

A display panel inspection system includes an inspection table, an imaging unit, a driving unit, and a control unit. The inspection table allows an inspection target to be placed thereon. The imaging unit radiates ultraviolet light onto an organic layer inspection region located in a non-display area surrounding a display area of the inspection target and located outside display area and generates an image of the organic layer inspection region based on the radiated ultraviolet light. The driving unit moves the imaging unit on the organic layer inspection region. The control unit determines whether an organic layer is present in the organic layer inspection region by analyzing the image generated by the imaging unit.

This application claims priority to Korean Patent Application No. 10-2024-0146383, filed on Oct. 24, 2024, and all the benefits accruing therefrom under 35 U.S.C. § 119, the content of which in its entirety is herein incorporated by reference.

### BACKGROUND

### 1. Field

The present disclosure relates to an inspection method and an inspection system, and more specifically, to a method and system for inspecting whether organic material is present in a non-display area after forming an organic encapsulation layer on a display panel.

### 2. Description of the Related Art

Automated Optical Inspection (AOI) systems are equipment used to automatically inspect defects in components or products during manufacturing processes. By utilizing cameras and optical equipment to capture high-resolution images and analyzing these images with software to evaluate the quality, AOI systems identify defects in inspection targets. AOI is predominantly employed in manufacturing processes of products such as printed circuit boards, semiconductors, or display panels, to detect defects related to the reliability of the products.

In the encapsulation process of a display panel, an inorganic layer may serve to block the penetration of moisture and air, while an organic layer provided between inorganic layers facilitates the planarization and stabilization of the inorganic layer. During the deposition of the organic layer, however, in a case where organic material is applied to the non-display area, defects such as pixel shrinkage or dark spots may occur. Thus, AOI can be employed to detect an organic material applied to the non-display area, thereby enabling the detection of defects and enhancing the reliability of the display panel.

### SUMMARY

In a process of detecting an organic material applied to the non-display area using Automated Optical Inspection (AOI), challenges arise when the spacing between structures in the inspection area is narrow or the density of structures is high, which diminishes visibility during optical inspection and makes it difficult to visually confirm the presence of organic material. Furthermore, if the organic layer is transparent, the captured image may show overlapping layers beneath the organic layer. Accordingly, improved methods to enhance the accuracy of AOI may be desired.

The present disclosure aims to address the above-described problems by providing an inspection method and an inspection system that utilize the refractive properties of organic material. Specifically, the disclosure provides an inspection method and an inspection system that improve the visibility of organic material during optical inspection by leveraging the characteristic that refractive effects become more pronounced with shorter wavelengths of light.

A display panel inspection system according to an embodiment of the disclosure includes an inspection table, an imaging unit, a driving unit, and a control unit. In such an embodiment, the inspection table allows an inspection target to be placed thereon. In such an embodiment, the imaging unit radiates ultraviolet light onto an organic layer inspection region located in a non-display area surrounding a display area of the inspection target and located outside the display area and generates an image of the organic layer inspection region based on the radiated ultraviolet light. In such an embodiment, the driving unit moves the imaging unit relative to the inspection target on the organic layer inspection region. In such an embodiment, the control unit determines whether an organic layer is present in the organic layer inspection region by analyzing the image generated by the imaging unit.

In an embodiment, the organic layer inspection region may include a boundary between an area where the organic layer is applied and an area where the organic layer is not applied on the inspection target.

In an embodiment, the control unit may extract a target position from a structure for preventing a flow of organic material located in the non-display area in the image and extract a gray value of the target position. In such an embodiment, the structure for preventing the flow of organic material may include an inclined surface that protrudes from the inspection target and is inclined in a direction intersecting a display direction. In such an embodiment, the target position may be on the inclined surface.

In an embodiment, the control unit may compare the gray value extracted from the target position to a reference value and determine that an organic layer may be present at the target position when the extracted gray value is greater than the reference value.

In an embodiment, the control unit may determine that the inspection target is defective when the target position is located farther from the display area than a reference position.

In an embodiment, the control unit may determine that no organic layer may be present in regions adjacent to the organic layer inspection region and not captured by the imaging unit when it is determined that no organic layer is present in the target position.

In an embodiment, the imaging unit may include a light source unit, a light guide unit, an objective lens, a camera, and a half-mirror unit. In such an embodiment, the light source unit may radiate the ultraviolet light onto the organic layer inspection region. In such an embodiment, the light guide unit may be positioned at one end of the light source unit. In such an embodiment, the objective lens may be connected to one end of the light guide unit to transmit the ultraviolet light reflected from the organic layer inspection region therethrough. In such an embodiment, the camera may be connected to another end of the light guide unit to receive the ultraviolet light transmitted through the objective lens and form an image. In such an embodiment, the half-mirror unit may be positioned within the light guide unit to direct the ultraviolet light radiated from the light source unit to the organic layer inspection region and to direct the ultraviolet light reflected from the organic layer inspection region to the camera.

In an embodiment, the imaging unit may further include an ultraviolet band-pass filter disposed in front of the camera.

In an embodiment, the camera may be a monochrome camera or an ultraviolet (UV) camera.

In an embodiment, the half-mirror unit may include a first half-mirror and a second half-mirror. In such an embodiment, the first half-mirror may reflect the ultraviolet light radiated from the light source unit in a first direction to change the direction of the reflected ultraviolet light to a second direction intersecting the first direction. In such an embodiment, the second half-mirror may reflect the ultraviolet light incident thereon in the second direction to change the direction of the incident light to the first direction to direct the ultraviolet light to the organic layer inspection region and allow the ultraviolet light reflected from the organic layer inspection region to transmit therethrough.

In an embodiment, the half-mirror unit may include a first half-mirror and a second half-mirror. In such an embodiment, the first half-mirror may transmit the ultraviolet light radiated in a first direction from the light source unit to the organic layer inspection region and reflect the ultraviolet light reflected from the organic layer inspection region in a second direction intersecting the first direction. In such an embodiment, the second half-mirror may reflect the ultraviolet light incident thereon in the second direction to the first direction to direct the ultraviolet light to the camera.

In an embodiment, the driving unit may include a support and a first movement rail. In such an embodiment, the imaging unit may be disposed on the support. In such an embodiment, the first movement rail may move the support in a first direction. In such an embodiment, the support may include a second movement rail which moves the imaging unit in a second direction intersecting the first direction.

In an embodiment, the driving unit may include a third movement rail which moves the inspection table in a first direction.

A method for inspecting a display panel according to an embodiment of the disclosure includes: placing a light source and a camera together on an organic layer inspection region located in a non-display area surrounding a display area of the inspection target and located outside the display area; radiating ultraviolet light onto the organic layer inspection region using the light source; receiving the ultraviolet light reflected from the organic layer inspection region via the camera; and determining whether an organic layer is present in the organic layer inspection region by analyzing an image generated based on the received ultraviolet light.

In an embodiment, the organic layer inspection region may include a boundary between an area where the organic layer is applied and an area where the organic layer is not applied on the inspection target.

In an embodiment, the determining whether the organic layer is present may include: extracting a target position from a structure for preventing a flow of organic material located in the non-display area in the image; and extracting a gray value of the target position. In such an embodiment, the structure for preventing the flow of organic material may include an inclined surface that protrudes from the inspection target and is inclined in a direction intersecting the display direction. In such an embodiment, the target position may be on the inclined surface.

In an embodiment, the determining whether the organic layer is present may further include: comparing the gray value extracted from the target position to a reference value; and determining that an organic layer is present when the extracted gray value is greater than the reference value.

In an embodiment, the determining whether the organic layer is present may further include determining that, in the case where an organic layer is determined to be present in the target position, the inspection target is defective when the target position is located farther from the display area than a reference position.

In an embodiment, the determining whether the organic layer is present may further include determining that no organic layer is present in regions adjacent to the organic layer inspection region and not captured by the camera when the target position is determined to have no organic layer present therein.

In an embodiment, the determining whether the organic layer is present may be performed substantially simultaneously with the placing the light source and the camera together.

According to embodiments of the present disclosure, by radiating short-wavelength light during optical inspection, it is possible to enhance the visibility of organic material by utilizing refractive effects.

In such embodiments, by accurately identifying areas where the organic material is applied, it is possible to determine defects in the display panel and ensure the reliability of the manufacturing process.

### BRIEF DESCRIPTION OF THE DRAWINGS

These and/or other features of embodiments of the present disclosure will become apparent and more readily appreciated from the following description of embodiments, taken in conjunction with the accompanying drawings, in which:

FIG. 1 is a block diagram of an inspection system according to an embodiment of the present disclosure;

FIG. 2 is a perspective view of an inspection system according to an embodiment of the present disclosure;

FIG. 3 is a plan view of an imaging unit according to an embodiment of the present disclosure;

FIG. 4 is a flowchart illustrating an inspection method according to an embodiment of the present disclosure;

FIG. 5 is a plan view of a display panel according to an embodiment of the present disclosure;

FIG. 6 is a cross-sectional view of the display panel taken along line I-I′ of FIG. 5;

FIG. 7A is a cross-sectional view of the display panel taken along line I-I′ of FIG. 5 according to the inspection method of FIG. 4;

FIG. 7B is an enlarged view of region AA shown in FIG. 7A;

FIG. 8A is an image formed as a result of an inspection according to an embodiment of the present disclosure in which case a monomer is not present;

FIG. 8B is an image formed as a result of an inspection according to an embodiment of the present disclosure in which case a monomer is present;

FIGS. 9A and 9B are images of inspection results according to an embodiment of the present disclosure; and

FIGS. 10A and 10B are images of inspection results according to an embodiment of the present disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

In the accompanying drawings, the thicknesses, ratios, and dimensions of the elements may not be to exact scale and may have been exaggerated for the benefit of effective explanation of the technical features associated with these elements. As such, the present disclosure shall not be restricted to the thicknesses, ratios, dimensions, etc. illustrated in the drawings.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

In the present disclosure, any “system,” “module,” “unit,” or “part” encompass implementations in computer-related software, hardware, or a combination of software and hardware.

In the present disclosure, first to third directions DR1, DR2, DR3 may be defined. The display panel may be formed to include pixels on a plane defined by the first direction DR1 and the second direction DR2. The third direction DR3 may be defined as the thickness direction of the display panel, and the first to third directions DR1, DR2, DR3 may be mutually orthogonal or intersecting.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

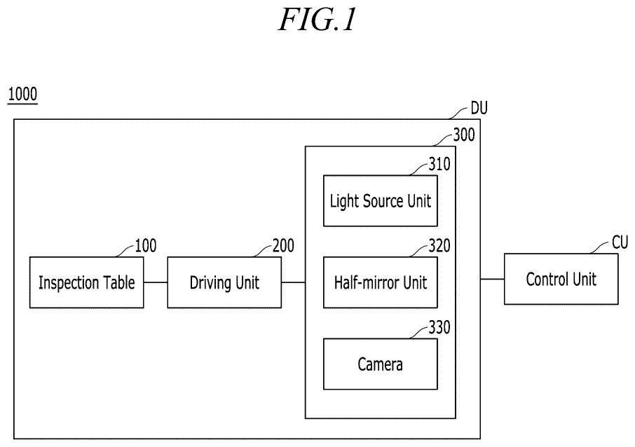

FIG. 1 is a block diagram of an inspection system 1000 according to an embodiment of the present disclosure. An embodiment of the inspection system 1000 may include an inspection unit DU and a control unit CU. The inspection unit DU may include an inspection table 100, a driving unit 200, and an imaging unit 300.

The inspection table 100 may be a plane or device on which an inspection target, e.g., a display panel, is placed. The inspection table 100 may be configured to stably secure the inspection target to ensure that inspection is performed without vibration.

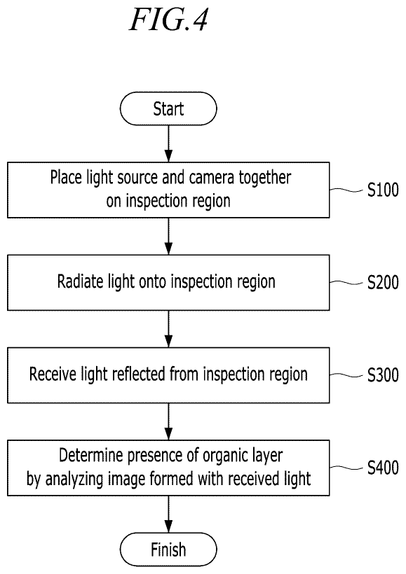

The driving unit 200 may be configured to control the position of the inspection table 100 or the imaging unit 300 to inspect specific regions of the inspection target. Here, it shall be understood that an inspection region or specific region may refer to at least a part of the inspection target where defects are likely to occur. The inspection region will be described in detail with reference to FIG. 4. The driving unit 200 may be configured to receive coordinates, which are position information corresponding to the inspection region, from the control unit CU. The driving unit 200 may be configured to control the movement of the inspection table 100 or the imaging unit 300 through, for example, moving rails, drive motors, and/or actuators to inspect the inspection region corresponding to the received coordinates.

The imaging unit 300 may be spaced apart from the inspection target placed on the inspection table 100 and configured to capture the inspection region to form an image. The imaging unit 300 may include a light source unit 310, a half-mirror unit 320, and a camera 330.

The light source unit 310 may be configured to radiate light onto the inspection region. The intensity of the light may be adjustable to select an optimal strength for each inspection condition. Additionally, the light source unit 310 may be configured to use filters to allow only specific wavelengths of light to pass or configured to utilize a light source that emits light in specific band to adjust the wavelength of the light. In an embodiment, the light source unit 310 may be configured to emit ultraviolet light, e.g., light with a wavelength of about 400 nanometers (nm) or less, to perform the inspection.

The half-mirror unit 320 may be configured to reflect a portion of the incident light while transmitting the remaining light, thereby dividing the light path. Accordingly, the half-mirror unit 320 may be configured to control the light path so that light irradiation via the light source unit 310 and image formation via the camera 330 can be simultaneously processed. The half-mirror unit 320 may include at least one or more half mirrors. The specific reflection and transmission ratios of the half mirrors may be selected depending on the purpose and conditions of the inspection.

The camera 330 may be configured to receive light reflected from the inspection region and form an image. The camera 330 may be configured to convert the light received by an image sensor of the camera 330 into an electrical signal and further into a digital signal to generate an image. The camera 330 may include a storage device configured to store captured images of the inspection region and may be configured to transmit these images to the control unit CU. In an embodiment, the camera 330 may be a monochrome camera or an ultraviolet (UV) camera.

The control unit CU may be configured to manage, execute, and control the overall operation of the inspection system 1000. The control unit CU may be configured to perform inspection operations, control inspection conditions, and determine defects. During the inspection operation, the control unit CU may be configured to receive information related to the progress of the inspection, such as the start and end of the inspection, and to perform the inspection accordingly. The control unit CU may be configured to automatically manage the inspection procedure and enable the inspection system 1000 to perform the predetermined task for each step. Additionally, the control unit CU may be configured to provide information to or control the driving unit 200 and/or the imaging unit 300 to adjust inspection conditions. In an embodiment, for example, the control unit CU may be configured to obtain coordinate information corresponding to the location of the inspection region and transmit the coordinate information to the driving unit 200 to adjust the imaging position. Furthermore, the control unit CU may be configured to control the imaging unit 300 to adjust resolution, light intensity, or irradiation angle. During a defect determination (or inspection) operation, the control unit CU may be configured to analyze the images obtained from the imaging unit 300 to identify defects in the inspection target. The control unit CU may be configured to rely on defect criteria and tolerances set according to the type and characteristics of the inspection to determine defects. The defect determination operation performed by the control unit CU will be described in detail with reference to FIG. 4.

The control unit CU may include a processor, a memory, and a storage. The inspection operations, inspection condition controls, and defect determination operations of the control unit CU may be implemented in firmware or software. In an embodiment, for example, the firmware may be stored in the storage and loaded into the memory when executed. The processor may be configured to execute the firmware loaded into the memory. However, the disclosure is not limited to this configuration, and the control unit CU may be configured with separate hardware to perform operations. In an embodiment, for example, the control unit CU may be implemented using dedicated logic circuits such as a Field Programmable Gate Array (FPGA) or an Application-Specific Integrated Circuit (ASIC) for performing defect determination operations. Additionally, the control unit CU may include a display unit, such as a monitor or a tablet, to display the received information or defect determination results.

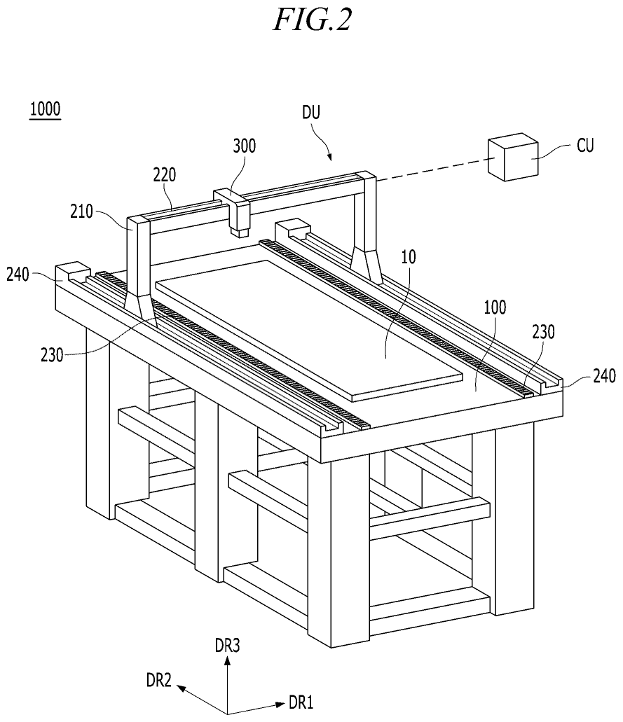

FIG. 2 is a perspective view of an inspection system 1000 according to an embodiment of the present disclosure. Referring to FIG. 2, an embodiment of the inspection unit DU may include an inspection table 100, a support 210, an imaging unit movement rail 220, an inspection table movement rail 230, a support movement rail 240, and an imaging unit 300. Here, the support 210, the imaging unit movement rail 220, the inspection table movement rail 230, and the support movement rail 240 may be included in (or elements of) the driving unit 200 described above with reference to FIG. 1. The control unit CU may be connected to the inspection unit DU via wired or wireless communication. In an embodiment where the control unit CU is connected to the inspection unit DU via a wired connection, the control unit CU may be connected via electrical cables or optical cables to transmit signals. In an embodiment where the control unit CU is connected to the inspection unit DU via a wireless connection, the control unit CU may be connected via a communication interface, such as Wi-Fi® or Bluetooth®.

The inspection table 100 may allow a display panel 10, which is the inspection target, to be placed thereon. The inspection table 100 may be configured to move in a second direction DR2 via the inspection table movement rail 230. By moving the inspection table 100 while keeping the imaging unit 300 stationary, the inspection region of the display panel 10 can be photographed. Additionally, the inspection table 100 may sequentially move a plurality of display panels 10 via the inspection table movement rail 230 for continuous inspection.

The support 210 may serve the function of securely mounting and stabilizing the imaging unit 300. The support 210 may be configured to move in the second direction DR2 via the support movement rail 240, resulting in the imaging unit 300 moving simultaneously when the support 210 moves. The support movement rail 240 may be driven to move the imaging unit 300 in the second direction DR2 while the display panel 10 remains stationary. Moreover, the support 210 may have the imaging unit movement rail 220 installed thereon. The imaging unit 300 may be configured to move in the first direction DR1 via the imaging unit movement rail 220.

The driving unit 200 may be configured to drive the imaging unit movement rail 220, the inspection table movement rail 230, and the support movement rail 240 to move the inspection table 100 or the imaging unit 300 to a position corresponding to the coordinates received from the control unit CU. This will allow precise identification of the inspection position and enable the imaging unit 300 to photograph the inspection region.

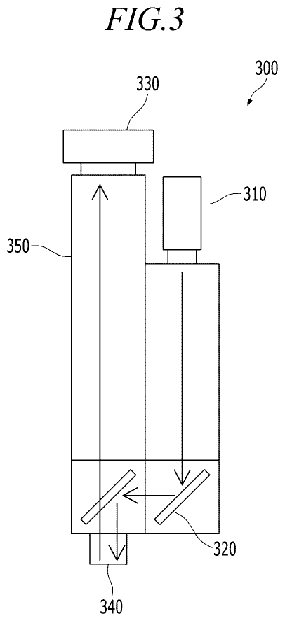

The imaging unit 300 may be mounted on the support 210 and spaced apart from the display panel 10 on the inspection table 100 in the third direction DR3 to capture the image of the inspection region. Moreover, the imaging unit 300 may be configured to transfer the captured image to the control unit CU. After capturing the image of the inspection region, the inspection results may be transmitted to the control unit CU, which is connected with the inspection unit DU via wired or wireless communication, for defect inspection. It should be appreciated that the mounting structure of the imaging unit 300 is not limited to what is shown in FIG. 3.

FIG. 3 is a plan view of an imaging unit 300 according to an embodiment of the present disclosure. Referring to FIG. 3, an embodiment of the imaging unit 300 may include a light source unit 310, a half-mirror unit 320, a camera 330, an objective lens 340, and a light guide unit 350.

In an embodiment, as illustrated in FIG. 3, light radiated from the light source unit 310 may pass through the light guide unit 350, which is positioned at one end of the light source unit 310, and be incident on the half-mirror unit 320 located inside the light guide unit 350. The light incident on the half-mirror unit 320 may be either reflected or transmitted and transferred to the inspection region. Light reflected from the inspection region may pass through the objective lens 340, which is connected to one end of the light guide unit 350, and be received by the camera 330, which is connected to another end (or an opposing end) of the light guide unit 350.

The half-mirror unit 320 may include a plurality of half mirrors. In an embodiment of the disclosure, the half-mirror unit 320 may include, as shown in FIG. 3, a first half mirror, which is configured to reflect light radiated from the light source unit 310 in a first direction and redirect the light to a second direction intersecting the first direction, and a second half mirror, which is configured to reflect light incident thereon in the second direction back to the first direction and transfer the light to the inspection region while transmitting the light reflected from the inspection region. Alternatively, by altering the orientation of the half mirrors, the half-mirror unit 320 may include: a first half mirror that is configured to transmit light radiated from the light source unit 310 in the first direction to the inspection region and reflect light reflected from the inspection region in the second direction; and a second half mirror that is configured to reflect the light incident thereon in the second direction back to the first direction to transfer the light to the camera 330.

The objective lens 340 may be configured to focus light reflected from the inspection region. In an embodiment, the objective lens 340 may be an ultraviolet (UV) lens configured to transmit light in ultralight band (ultraviolet or UV light) while blocking visible light or infrared light. Although FIG. 3 shows an embodiment where light radiated from the light source unit 310 passes through the objective lens 340 to reach the inspection region and that light reflected from the inspection region is received through the same objective lens 340, the paths of light are not limited to this configuration. In an embodiment, while the objective lens 340 may be the location where light reflected from the inspection region is received, the aperture through which light radiated from the light source unit 310 is emitted to the inspection region may differ or be adjusted to change.

The light guide unit 350 may provide a pathway for light and minimize light loss. In an embodiment, the half-mirror unit 320 may be positioned inside the light guide unit 350. Additionally, a UV band-pass filter may be positioned in front of the camera 330 lens inside the light guide unit 350 to ensure that the camera 330 only receives ultraviolet light. The shape of the light guide unit 350 is not limited to the plan view illustrated in FIG. 3.

FIG. 4 is a flowchart illustrating an inspection method according to an embodiment of the present disclosure. Referring to FIG. 4, an embodiment of the display panel inspection method may include: placing a light source and a camera together on an inspection region (S100); radiating light onto the inspection region (S200); receiving light reflected from the inspection region (S300); and determining the presence of an organic layer by analyzing an image formed with (or generated based on) the received light (S400). The display panel and elements encompassed therein that are identified in the following description of the display panel inspection method are identical to those described with reference to FIGS. 1 to 3.

In an embodiment of the present disclosure, if organic material spreads to the non-display area or overflows into the non-display area while forming an organic layer during an encapsulation process, moisture or air may penetrate through the organic layer located in the non-display area, leading to defects, such as pixel shrinkage or dark spots. Accordingly, the display panel inspection method may be performed to detect defects in the organic layer inspection region, which includes the boundary of the area where the organic layer is applied in the non-display area surrounding a display area of the inspection target and located outside the display area.

In the process of placing a light source and a camera together on an inspection region (S100), the control unit CU may control the driving unit 200 to position the imaging unit 300 on the inspection region of the display panel 10. Accordingly, the control unit CU may receive the coordinates of the organic layer inspection region and instruct the driving unit 200 to move the inspection table 100 or the imaging unit 300.

The organic layer inspection region may include a plurality of areas on the display panel 10. Since the structure of the area where the organic layer is applied and the boundary structure of the non-display area are consistent during the encapsulation process, the application pattern of the organic layer may also remain consistent. Therefore, inspecting only specific multiple positions instead of inspecting the entire boundary of the organic layer located in the non-display area may suffice to confirm the presence of defects, i.e., whether the organic layer is present in the non-display area. Accordingly, by not inspecting every boundary of the non-display area, it is possible to reduce the computational burden for defect detection and enhance the detection speed.

The process of radiating light onto the inspection region (S200) may be performed by the imaging unit 300. The imaging unit 300, having received inspection-related instructions from the control unit CU, may radiate light from the light source unit 310 onto the organic layer inspection region. In an embodiment, the wavelength of the emitted light may be about 400 nm or less.

In the process of receiving light reflected from the inspection region (S300), the camera 330 may receive the light reflected from the inspection region after the process of radiating light onto the inspection region (S200) to generate an image of the inspection region. In an embodiment, a UV filter may be applied to the camera 330 to allow the camera 330 to selectively receive ultraviolet light, i.e., light in ultraviolet band, as the refraction and absorption characteristics of an element differ by wavelength. Additionally, the camera 330 may be a UV camera to capture ultraviolet light, or a monochrome camera may be used to generate high-resolution and high-precision images.

In the process of determining the presence of an organic layer by analyzing an image formed with the received light (S400), the imaging unit 300 may form an image using the light received in the process of receiving light reflected from the inspection region (S300). The control unit CU may receive and analyze the image formed by the imaging unit 300 to determine the presence of the organic layer and detect defects. To determine defects, the control unit CU may extract a target position from a structure for preventing the flow of organic material located in the non-display area based on the captured image. The structure for preventing the flow of organic material may include a first inclined surface protruding from the display panel 10, which is the inspection target, and sloped in a direction intersecting the display direction. Accordingly, the target position extracted by the control unit CU may be provided or defined on the first inclined surface.

In an embodiment, the control unit CU may extract a gray value of the target position, which serves as a criterion for defect determination. The gray value, representing the brightness of each pixel in a digital image, may be in a range from 0 (complete black) to 255 (complete white), with intermediate values representing various shades of gray. In an embodiment, the control unit CU may extract the gray values, respectively, from multiple target positions.

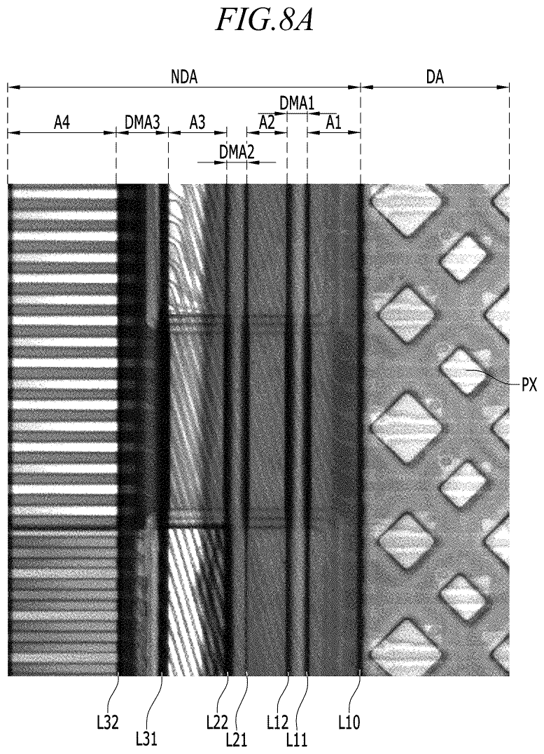

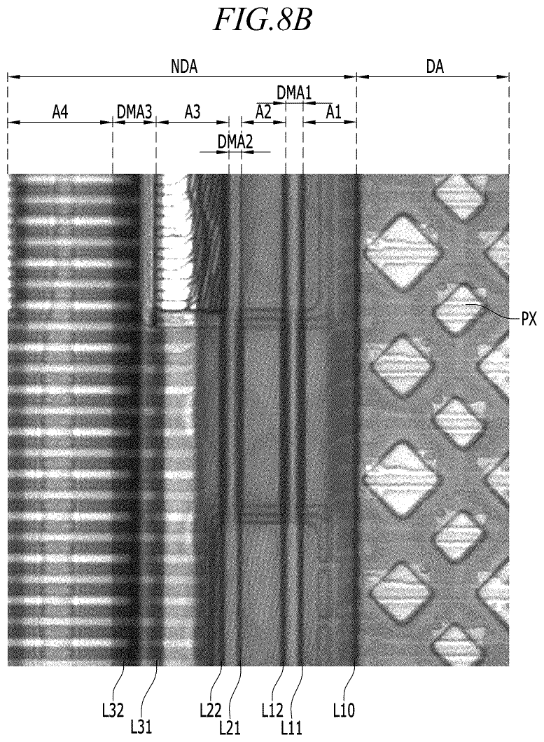

In such an embodiment, the control unit CU may compare the gray value extracted from the target position with a reference gray value. When the gray value of the target position is greater than the reference gray value, it is determined that the target position contains an organic layer, and defects can be identified based on this determination. The organic layer may consist of organic materials such as monomers or polymers. Accordingly, the organic layer may be transparent, and the transparency of the organic layer may make it difficult to detect using visible light. Therefore, shorter-wavelength ultraviolet light can be utilized to enhance the visibility of the organic layer by exploiting its refraction characteristics that are higher than the refraction of air. When ultraviolet light, instead of visible light, is radiated onto the organic layer inspection region, areas containing the organic layer, i.e., areas in which organic material is present, exhibit a more pronounced refraction effect, resulting in defocusing the captured image and thus reducing image sharpness. The reduction in sharpness may result in the gray value being higher than when the sharpness is not reduced. Therefore, by setting a specific reference gray value for areas without organic material, the presence of an organic layer can be determined by comparing the extracted gray value with the reference value. This may enhance the visibility of the organic layer and improve the accuracy of defect detection. In other words, when the gray value of the target position is greater than the reference value, it is determined that the organic material is present, as the refraction effect reduces the image sharpness. Embodiments related to this will be described in greater detail with reference to FIGS. 8A through 10B.

Additionally, in the process of determining the presence of an organic layer by analyzing an image formed with the received light (S400), the control unit CU may determine whether the inspection target is defective based on the locations where the organic layer is determined to be present. When it is determined that the organic layer is present at the target position, the control unit CU may determine that the inspection target is defective if the target position containing the organic layer is located farther from the display area than a reference position. The control unit CU may determine whether the inspection target is defective based on the boundary location of the organic layer assessed by comparing the gray value. The detailed processes by which the control unit determines the defect will be further described in detail with reference to FIGS. 8A through 10B.

When it is determined in the process of determining the presence of an organic layer by analyzing an image formed with the received light (S400) that no organic layer is present at the target position, the control unit CU may determine that no organic layer exists in adjacent regions of the organic layer inspection region not captured by the camera 330. Accordingly, by inspecting a plurality of organic layer inspection regions that do not overlap each other, the control unit CU can detect defects without inspecting the entire non-display area. The process of determining the presence of an organic layer by analyzing an image formed with the received light (S400) may be performed substantially simultaneously (e.g., immediately after with a minimum delay) with the process of placing a light source and a camera together on an inspection region (S100).

FIG. 5 is a plan view of a display panel 10 according to an embodiment of the present disclosure. Referring to FIG. 5, the display panel 10 may have a display area DA and a non-display area NDA defined therein. The display area DA may be configured to display images and may include a plurality of pixels that implement the images. The display panel 10 may be configured to control the pixels to display various images. Each pixel may include a transistor and a light-emitting diode. The light-emitting diode may include an organic light-emitting diode or a nano light-emitting diode. The non-display area NDA may surround the display area DA and may be shaped to locate outside the display area DA.

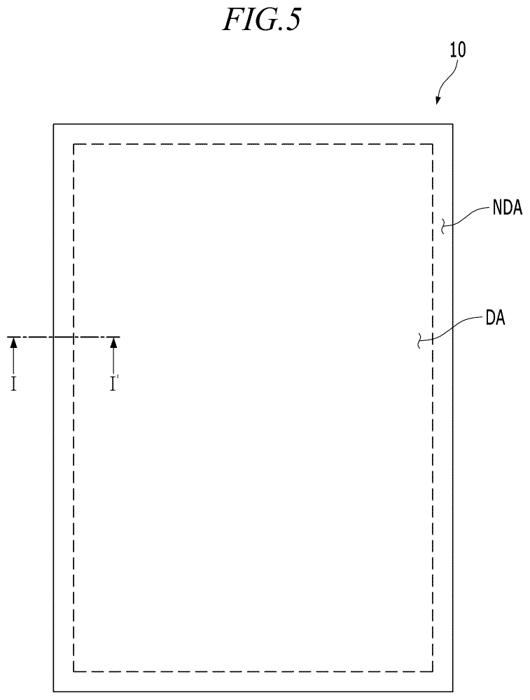

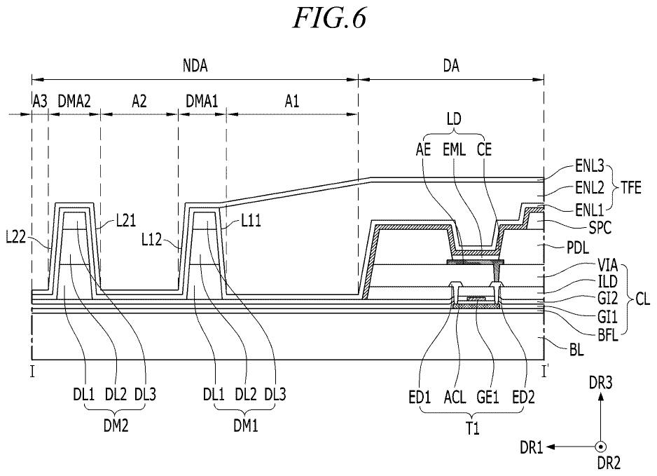

FIG. 6 is a cross-sectional view of the display panel 10 taken along line I-I′ of FIG. 5. Referring to FIG. 6, the display panel 10 may include a base layer BL, a circuit layer CL, a light-emitting diode LD, a pixel defining layer PDL, a spacer SPC, an encapsulation layer TFE, a first dam DM1, and a second dam DM2.

The circuit layer CL may include a buffer layer BFL, gate insulating layers GI1, GI2, an interlayer insulating layer ILD, a circuit insulation layer VIA, and a transistor T1.

The encapsulation layer TFE may seal the light-emitting diode LD, the pixel defining layer PDL, and the spacer SPC to protect the layer containing the light-emitting diode LD from external oxygen or moisture.

A buffer layer BFL may be disposed on one surface of the base layer BL. The buffer layer BFL may be configured to prevent impurities in the base layer BL from entering the pixels during the manufacturing process. Particularly, the buffer layer BFL may prevent the diffusion of impurities into an active area ACL of the transistor T1, which constitutes the pixel. Additionally, the buffer layer BFL may block moisture from penetrating the pixels from external sources.

The active area ACL, which constitutes the transistor T1, may be disposed on the buffer layer BFL. The active area ACL may include polycrystalline silicon or amorphous silicon, or alternatively, a metal oxide semiconductor. The active area ACL may include a channel region through which electrons or holes can move and a first ion-doped region and a second ion-doped region with the channel region interposed therebetween. The active area ACL may be disposed in the display area DA.

A first gate insulating layer GI1, which covers the active area ACL, may be disposed on the buffer layer BFL. The first gate insulating layer GI1 may include an organic film and/or an inorganic film. The first gate insulating layer GI1 may include a plurality of inorganic thin films, which may include a silicon nitride layer and a silicon oxide layer. A control electrode GE1, which constitutes the transistor T1, may be disposed on the first gate insulating layer GI1. The control electrode GE1 may be disposed in the display area DA.

A second gate insulating layer GI2, which covers the control electrode GE1, may be disposed on the first gate insulating layer GI1. The second gate insulating layer GI2 may include an organic film and/or an inorganic film. The second gate insulating layer GI2 may include or be defined by a plurality of inorganic thin films, which may include silicon nitride and silicon oxide layers.

The interlayer insulating layer ILD may be disposed on the second gate insulating layer GI2. The interlayer insulating layer ILD may include an organic film and/or an inorganic film. The interlayer insulating layer ILD may include or be defined by a plurality of inorganic thin films, which may include silicon nitride and silicon oxide layers.

A first electrode ED1 and a second electrode ED2 of the transistor T1 may be disposed on the interlayer insulating layer ILD located in the display area DA. The first electrode ED1 and the second electrode ED2 may be connected to the corresponding active area ACL through contact holes respectively penetrating (defined or formed) through the gate insulating layers GI1, GI2 and the interlayer insulating layer ILD.

The circuit insulation layer VIA, covering the first electrode ED1 and the second electrode ED2, may be disposed on the interlayer insulating layer ILD. The circuit insulation layer VIA may include an organic film and/or an inorganic film. The circuit insulation layer VIA may provide a planar surface. The circuit insulation layer VIA disposed in the display area DA may cover the transistor T1 in the display area DA.

The buffer layer BFL, the gate insulating layers GI1, GI2, and the interlayer insulating layer ILD may be disposed across the entire display area DA and non-display area NDA between the base layer BL and the circuit insulation layer VIA. Although FIG. 6 shows only one transistor T1 in the display area DA for convenience of illustration, the number of transistors in the display area DA is not limited to what is illustrated in FIG. 6.

The light-emitting diode LD and the pixel defining layer PDL may be disposed on the circuit insulation layer VIA located in the display area DA. The light-emitting diode LD may include an anode electrode AE, a hole control layer (not shown), an emission layer EML, an electron control layer (not shown), and a cathode electrode CE.

The anode electrode AE may be disposed on the circuit insulation layer VIA and may be connected to the first electrode ED1 or the second electrode ED2. The anode electrode AE may be disposed on and electrically connected to the transistor T1.

The pixel defining layer PDL may be disposed on the circuit insulation layer VIA. The pixel defining layer PDL may cover the pixels and may define and separate individual pixels. Moreover, the pixel defining layer PDL may be provided with a pixel aperture exposing at least a portion of the anode electrode AE.

The emission layer EML may be disposed on the anode electrode AE exposed through the pixel aperture of the pixel defining layer PDL. The emission layer EML may be positioned within the pixel aperture and may be interposed between the anode electrode AE and the cathode electrode CE. The emission layer EML may include an organic light-emitting material.

The cathode electrode CE may be disposed on the emission layer EML and may be disposed on the entire pixel defining layer PDL.

The spacer SPC may be disposed on the pixel defining layer PDL. The spacer SPC may be configured to maintain a separation distance during the formation of the emission layer EML, thereby effectively preventing layer overlap or damage. The spacer SPC may be formed simultaneously with the pixel defining layer PDL to ensure uniform interlayer arrangement.

The encapsulation layer TFE may be disposed on the cathode electrode CE. The encapsulation layer TFE may cover the light-emitting diode LD and include at least one inorganic encapsulation layer and at least one organic encapsulation layer. In an embodiment, the encapsulation layer TFE may include a first inorganic encapsulation layer ENL1, an organic encapsulation layer ENL2, and a second inorganic encapsulation layer ENL3.

The first inorganic encapsulation layer ENL1 may be disposed on the cathode electrode CE. The first inorganic encapsulation layer ENL1 and the second inorganic encapsulation layer ENL3 may be disposed across the entire display area DA and non-display area NDA. In an embodiment, the first inorganic encapsulation layer ENL1 and the second inorganic encapsulation layer ENL3 may be disposed on the first dam DM1 and the second dam DM2.

The organic encapsulation layer ENL2 may be disposed on the first inorganic encapsulation layer ENL1. The organic encapsulation layer ENL2 may cover the display area DA.

The organic encapsulation layer ENL2 may include or be made of organic materials, such as monomers or polymers. The organic encapsulation layer ENL2 may be positioned between the first inorganic encapsulation layer ENL1 and the second inorganic encapsulation layer ENL3 to prevent delamination of the encapsulation layer TFE caused by foreign substances. Additionally, the organic encapsulation layer ENL2 may have a refractive index greater than that of air.

The first dam DM1 and the second dam DM2 may be disposed in the non-display area NDA. The first dam DM1 and the second dam DM2 may be configured to prevent overflow of organic material, such as monomers, during the formation of the organic encapsulation layer ENL2. Accordingly, the first dam DM1 and the second dam DM2 may each serve as the structure for preventing the flow of organic material. In an embodiment, the first dam DM1 and the second dam DM2 may prevent organic material from overflowing in the outward direction of the non-display area NDA, i.e., in the first direction DR1. If overflow does not occur, the organic encapsulation layer ENL2 may remain inside the first dam DM1. In such a case, the boundary of the organic encapsulation layer ENL2 may be positioned in the first region A1.

The first dam DM1 and the second dam DM2 may be disposed in the non-display area NDA on the second gate insulating layer GI2. In an embodiment, the first dam DM1 may be spaced apart from the display area DA in the first direction DR1 and positioned in a first dam area DMA1. Additionally, the second dam DM2 may be spaced apart from the first dam DM1 in the first direction DR1, positioned outside the first dam DM1, and located in a second dam area DMA2.

The first dam DM1 and the second dam DM2 may each form a structure in which multiple layers are laminated. In an embodiment, the first dam DM1 and the second dam DM2 may each include a first layer DL1, a second layer DL2, and a third layer DL3. In an embodiment, for example, the first layer DL1 may be formed substantially simultaneously with the circuit insulation layer VIA. The second layer DL2 may be formed simultaneously with the pixel defining layer PDL, and the third layer DL3 may be formed simultaneously with the spacer SPC. Although FIG. 6 illustrates an embodiment where each of the first dam DM1 and the second dam DM2 has a laminated structure with three layers, the number of dams in the non-display area NDA and the internal laminated structures of the dams are not limited to this configuration.

In an embodiment, as the first dam DM1 and the second dam DM2 are laminated in the display direction, i.e., in the third direction DR3, the first dam DM1 and the second dam DM2 may have slopes in a direction intersecting the third direction DR3. Accordingly, the first dam DM1 and the second dam DM2 may include first inclined surfaces L11, L21 and second inclined surfaces L12, L22, respectively. In an embodiment, to analyze the presence of the organic layer, the positions of the inclined surfaces L11, L12, L21, L22 of the first dam DM1 and the second dam DM2 may be detected or extracted, and the gray values of these positions may be detected or extracted.

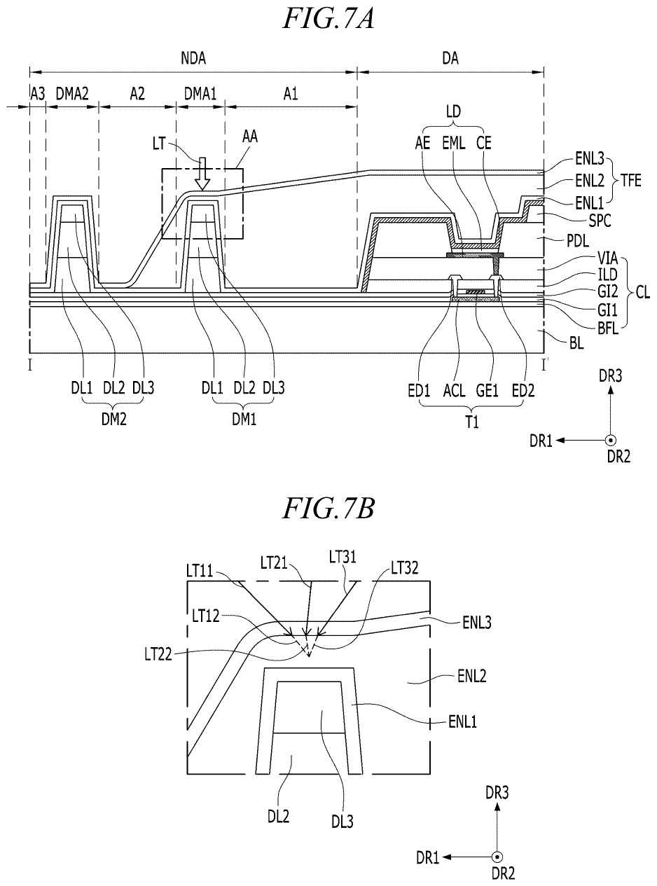

FIGS. 7A and 7B are cross-sectional views illustrating an embodiment of the inspection method described in FIG. 4, showing the irradiation of inspection light LT. In an embodiment, the inspection system 1000 may be configured to inspect whether the organic encapsulation layer ENL2 is present in the non-display area NDA. By inspecting the non-display area NDA using the inspection method of FIG. 4, defects in the display panel 10 can be detected, thereby ensuring reliability. In an embodiment, the inspection light LT may be radiated after forming the organic encapsulation layer ENL2. Since the light transmittances of the organic encapsulation layer ENL2 and the second inorganic encapsulation layer ENL3 differ depending on the wavelength of light, and the organic encapsulation layer ENL2 is laminated thicker than the inorganic encapsulation layer ENL3, the refraction effect of the organic encapsulation layer ENL2 may be more pronounced. Therefore, the organic encapsulation layer ENL2 may be inspected even after the formation of the second inorganic encapsulation layer ENL3.

FIG. 7A is a cross-sectional view of the display panel 10 taken along line I-I′ of FIG. 5, according to the inspection method of FIG. 4. FIG. 7A illustrates a case where an overflow of organic material, such as monomers, occurs during the formation of the organic encapsulation layer ENL2, causing the organic encapsulation layer ENL2 to extend to a second area A2 outside the first dam DM1. In such a case, the boundary of the organic encapsulation layer ENL2 may be located in the second area A2.

Referring to FIG. 7A, the inspection light LT may be radiated onto the organic layer inspection region located in the non-display area NDA. FIG. 7A shows an example where the inspection light LT is radiated onto the first dam DM1.

FIG. 7B is an enlarged view of region AA of the display panel 10 shown in FIG. 7A. As illustrated in FIG. 7B, the inspection light LT of FIG. 7A is divided into a first incident light LT11, a second incident light LT21, and a third incident light LT31, which are incident on the first dam DM1 (see FIG. 7A). When the incident lights LT11, LT21, LT31 are incident at the organic encapsulation layer ENL2, the organic material forming the organic encapsulation layer ENL2, having a higher refractive index than air, may cause the incident lights LT11, LT21, LT31 to refract into first refracted light LT12, second refracted light LT22, and third refracted light LT32, respectively. Examples of the refracted angles and directions of the refracted lights LT12, LT22, LT32 are illustrated in FIG. 7B.

The refraction effect may increase as the wavelength of the inspection light LT decreases. In an embodiment, by radiating the inspection light LT in ultraviolet band with a wavelength shorter than visible light, the refraction effect can be intensified when the inspection light LT is incident at the organic encapsulation layer ENL2. As shown in FIG. 7B, as the refraction effect increases, the incident lights LT11, LT21, LT31 exhibit larger refraction angles and refract into respective refracted lights LT12, LT22, LT32 at the boundary of the organic encapsulation layer ENL2. Unlike when the organic encapsulation layer ENL2 is not present, the variation in refraction angles may cause a defocusing effect, thereby preventing the focus from converging at a single point. As a result, when defocusing occurs, the area containing the organic encapsulation layer ENL2 may exhibit reduced sharpness in the captured image, resulting in higher gray values in the corresponding area.

In an embodiment, the presence of the organic encapsulation layer ENL2 may be determined by extracting high-sharpness positions in the image, such as the inclined surfaces L11, L12, L21, L22 of the first dam DM1 and the second dam DM2 (see FIG. 6) and comparing the gray values of these positions with a reference gray value. In an embodiment, for example, when the reference gray value is 40 and the gray values of the inclined surfaces L11, L12, L21, L22 of the first dam DM1 and the second dam DM2 exceed 40, the organic encapsulation layer ENL2 may be determined to be present.

FIGS. 8A and 8B show images formed as a result of inspection according to an embodiment of the present disclosure. FIGS. 8A and 8B illustrate the results of inspecting the inspection region of the display panel 10 using the inspection system 1000. Each of these images represents the results, depending on the presence or absence of monomers, obtained when ultraviolet light is radiated onto the inspection region and then captured by the camera. FIG. 8A illustrates an image formed when monomers are absent, as a result of inspection according to an embodiment of the present disclosure. FIG. 8B illustrates an image formed when monomers are present, as a result of inspection according to an embodiment of the present disclosure. A plurality of pixels PX may be present in the display area DA, and the first dam area DMA1, the second dam area DMA2, and the third dam area DMA3 may be present in the non-display area NDA. The spaced regions between the display area DA and the respective dam areas may be represented as multiple regions A1, A2, A3, A4.

To identify the application area of the monomers, the locations of the inclined surface L10 of the display area, the first inclined surface L11 and the second inclined surface L12 of the first dam, the first inclined surface L21 and the second inclined surface L22 of the second dam, and the first inclined surface L31 and the second inclined surface L32 of the third dam may be extracted from the image. By extracting the gray values at these locations and comparing the values for a case where monomers are present and a case where monomers are absent, it can be confirmed that the gray values are higher when monomers are present. Referring to FIGS. 8A and 8B, when monomers, i.e., the organic encapsulation layer ENL2, are present, as shown in FIG. 8B, the sharpness of the inclined surfaces L10, L11, L12, L21, L22, L31, L32 decreases. Accordingly, the gray values of the regions where the organic encapsulation layer ENL2 is present may have higher values.

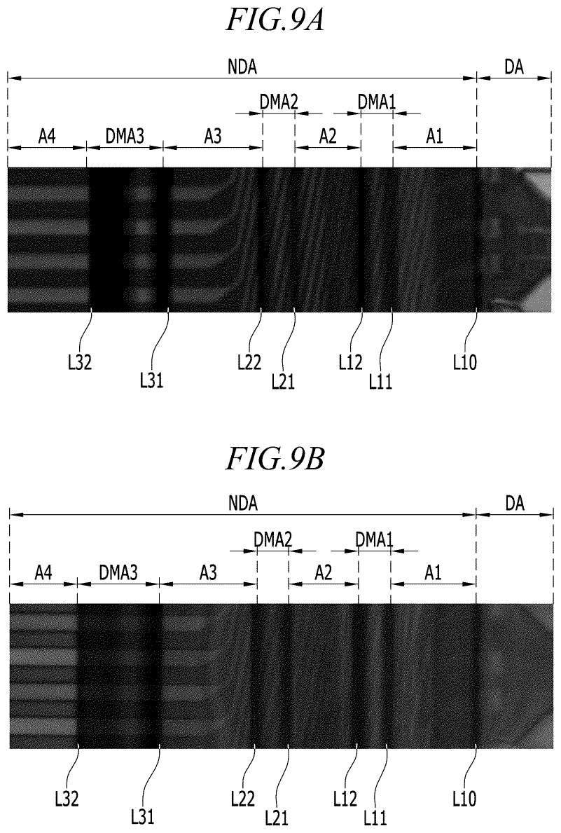

FIGS. 9A and 9B illustrate inspection result images according to an embodiment of the present disclosure. FIGS. 9A and 9B represent the same inspection region where monomers are present but are captured using inspection light of different wavelengths. FIG. 9A shows the image formed when visible light (400-800 nm wavelength range) is used as the inspection light, while FIG. 9B shows the image formed when ultraviolet light is used as the inspection light.

To identify the application area of the monomers, the positions of the inclined surface L10 of the display area, the first inclined surface L11 and the second inclined surface L12 of the first dam, the first inclined surface L21 and the second inclined surface L22 of the second dam, and the first inclined surface L31 and the second inclined surface L32 of the third dam may be extracted from the images. Upon extracting the gray values of these inclined surfaces, the results shown in Table 1 are obtained:

TABLE 1

| Light | | | | | | | |
|---|---|---|---|---|---|---|---|
| Source | L32 | L31 | L22 | L21 | L12 | L11 | L10 |
| Visible | 15 | 14 | 18 | 24 | 17 | 29 | 22 |
| Light | | | | | | | |
| UV Light | 29 | 20 | 34 | 34 | 32 | 45 | 43 |

By analyzing the gray values of the inclined surfaces L10, L11, L12, L21, L22, L31, L32, it is confirmed that when ultraviolet inspection light is used, the gray values of the locations containing monomers, such as the inclined surface L10 of the display area and the first inclined surface L11 of the first dam, are higher than those at other locations. However, when visible light is used, the differences in gray values between locations with and without monomers are smaller, resulting in lower accuracy. Therefore, using short-wavelength ultraviolet inspection light can improve the visibility of monomers and enhance the accuracy in determining the presence of the organic encapsulation layer ENL2.

Moreover, in an embodiment, as shown in FIG. 9, the boundary of the organic encapsulation layer ENL2 can be determined based on the positions where monomers are confirmed, that is, the inclined surface L10 of the display area and the first inclined surface L11 of the first dam. In an embodiment, for example, when monomers are found on the first inclined surface L11 of the first dam but not on the second inclined surface L12 of the first dam, the boundary of the organic encapsulation layer ENL2 may be located in the first region A1. The boundary of the organic encapsulation layer ENL2 can also be used to assess defects in the inspection target. In an embodiment, for example, when determining defects in the display panel 10, in a case where the boundary of the organic encapsulation layer ENL2 is located in the first region A1, the second region A2, and the third region A3, the display panel 10 may be determined to be non-defective. In such an embodiment, in a case where the boundary is located in the fourth region A4, the display panel 10 may be determined to be defective. In the embodiment shown in FIG. 9B, the inspection results indicate that the boundary of the organic encapsulation layer ENL2 is located in the first region A1, and thus the display panel 10 may be determined to be non-defective.

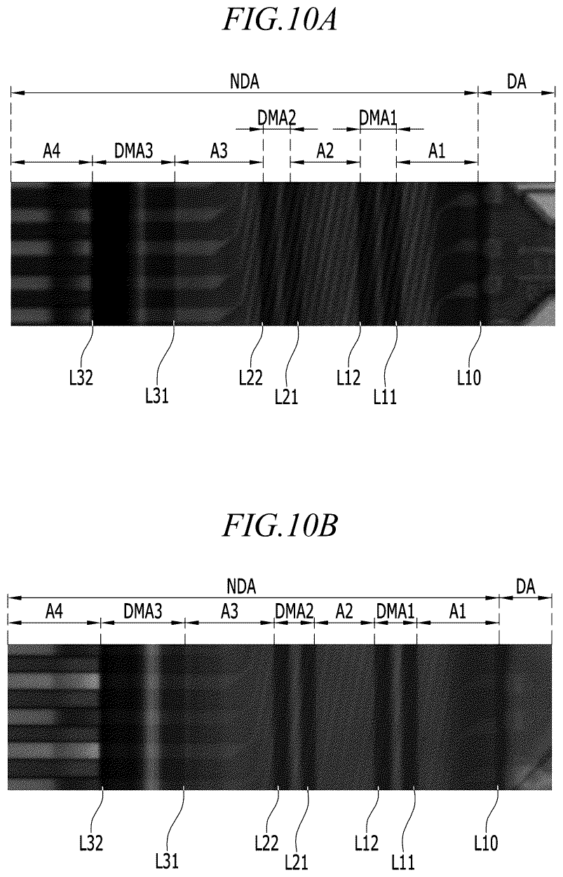

FIGS. 10A and 10B illustrate inspection result images according to an embodiment of the present disclosure. FIGS. 10A and 10B represent the same inspection region where monomers are present but are captured using inspection light of different wavelengths. FIG. 10A shows the image formed when visible light (400-800 nm wavelength range) is used as the inspection light, while FIG. 10B shows the image formed when ultraviolet light is used as the inspection light.

To identify the application area of the monomers, the positions of the inclined surface L10 of the display area, the first inclined surface L11 and the second inclined surface L12 of the first dam, the first inclined surface L21 and the second inclined surface L22 of the second dam, and the first inclined surface L31 and the second inclined surface L32 of the third dam may be extracted from the images. Upon extracting the gray values of these inclined surfaces, the results shown in Table 2 are obtained:

TABLE 2

| Light | | | | | | | |
|---|---|---|---|---|---|---|---|
| Source | L32 | L31 | L22 | L21 | L12 | L11 | L10 |
| Visible | 14 | 38 | 28 | 37 | 25 | 67 | 19 |
| Light | | | | | | | |
| UV Light | 24 | 56 | 54 | 55 | 54 | 55 | 57 |

By analyzing the gray values of the inclined surfaces L10, L11, L12, L21, L22, L31, L32, it is confirmed that, in the case of ultraviolet inspection light, the gray value of the second inclined surface L32 of the third dam, where no monomers are present, is smaller compared to other locations. However, when visible light is used, the gray value differences between locations with and without monomers are not as pronounced, leading to lower accuracy in detection. Accordingly, using short-wavelength ultraviolet inspection light can improve the visibility of monomers and enhance the accuracy in determining the presence of the organic encapsulation layer ENL2.

Moreover, the boundary of the organic encapsulation layer ENL2 can be determined based on the locations where monomers are found to be present. In the case shown in FIG. 10, monomers are confirmed to be present up to the first inclined surface L31 of the third dam, and thus the boundary of the organic encapsulation layer ENL2 may be located in the third region A3. When assessing defects in the inspection target based on the boundary of the organic encapsulation layer ENL2, if the organic encapsulation layer ENL2 is present in the fourth region A4, the display panel 10 may be determined to be defective. In the case shown in FIG. 10B, since the inspection results indicate that the organic encapsulation layer ENL2 is located in the third region A3, the display panel 10 may be determined to be non-defective.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display panel inspection system comprising:
an inspection table on which an inspection target is placed;
an imaging unit which radiates ultraviolet light onto an organic layer inspection region located in a non-display area surrounding a display area of the inspection target and located outside the display area and generates an image of the organic layer inspection region based on the radiated ultraviolet light;
a driving unit which moves the imaging unit relative to the inspection target on the organic layer inspection region; and
a control unit which determines whether an organic layer is present in the organic layer inspection region by analyzing the image generated by the imaging unit.

2. The display panel inspection system of claim 1, wherein the organic layer inspection region comprises a boundary between an area where the organic layer is applied and an area where the organic layer is not applied on the inspection target.

3. The display panel inspection system of claim 1, wherein the control unit extracts a target position from a structure for preventing a flow of organic material located in the non-display area in the image and extracts a gray value of the target position,
wherein the structure for preventing the flow of organic material comprises an inclined surface protruding from the inspection target and inclined in a direction intersecting a display direction, and
wherein the target position is on the inclined surface.

4. The display panel inspection system of claim 3, wherein the control unit compares the gray value extracted from the target position with a reference value and determines that the organic layer is present at the target position when the extracted gray value is greater than the reference value.

5. The display panel inspection system of claim 4, wherein the control unit determines that the inspection target is defective when the target position, where the organic layer is to be present, is located farther from the display area than a reference position.

6. The display panel inspection system of claim 4, wherein the control unit determines that no organic layer is present in regions adjacent to the organic layer inspection region and not captured by the imaging unit when it is determined that no organic layer is present in the target position.

7. The display panel inspection system of claim 1, wherein the imaging unit comprises:
a light source unit which radiates the ultraviolet light onto the organic layer inspection region;
a light guide unit positioned at one end of the light source unit;
an objective lens connected to one end of the light guide unit, wherein the objective lens allows the ultraviolet light reflected from the organic layer inspection region to transmit therethrough;
a camera connected to another end of the light guide unit, wherein the camera receives the ultraviolet light transmitted through the objective lens to form an image; and
a half-mirror unit disposed within the light guide unit, wherein the half-mirror unit directs the ultraviolet light radiated from the light source unit to the organic layer inspection region and directs the ultraviolet light reflected from the organic layer inspection region to the camera.

8. The display panel inspection system of claim 7, wherein the imaging unit further comprises an ultraviolet band-pass filter disposed in front of the camera.

9. The display panel inspection system of claim 7, wherein the camera is a monochrome camera or an ultraviolet camera.

10. The display panel inspection system of claim 7, wherein the half-mirror unit comprises:
a first half-mirror which reflects the ultraviolet light radiated from the light source unit in a first direction and redirects the ultraviolet light to a second direction intersecting the first direction; and
a second half-mirror which reflects the ultraviolet light incident thereon in the second direction to the first direction to direct the ultraviolet light to the organic layer inspection region and allows the ultraviolet light reflected from the organic layer inspection region to transmit therethrough.

11. The display panel inspection system of claim 7, wherein the half-mirror unit comprises:
a first half-mirror which transmits the ultraviolet light radiated from the light source unit in a first direction to the organic layer inspection region and reflects the ultraviolet light reflected from the organic layer inspection region to a second direction intersecting the first direction; and
a second half-mirror which reflects the ultraviolet light incident thereon in the second direction to the first direction to direct the ultraviolet light to the camera.

12. The display panel inspection system of claim 1, wherein the driving unit comprises:
a support on which the imaging unit is disposed; and
a first movement rail which moves the support in a first direction,
wherein the support comprises a second movement rail which moves the imaging unit in a second direction intersecting the first direction.

13. The display panel inspection system of claim 1, wherein the driving unit comprises a third movement rail which moves the inspection table in a first direction.

14. A method for inspecting a display panel, the method comprising:
placing a light source and a camera together on an organic layer inspection region located in a non-display area surrounding a display area of an inspection target and located outside the display area;
radiating ultraviolet light onto the organic layer inspection region using the light source;
receiving the ultraviolet light reflected from the organic layer inspection region via the camera; and
determining whether an organic layer is present in the organic layer inspection region by analyzing an image generated based on the received ultraviolet light.

15. The method of claim 14, wherein the organic layer inspection region comprises a boundary between an area where the organic layer is applied and an area where the organic layer is not applied on the inspection target.

16. The method of claim 14, wherein the determining whether the organic layer is present comprises:
extracting a target position from a structure for preventing a flow of organic material located in the non-display area in the image; and
extracting a gray value of the target position,
wherein the structure for preventing the flow of organic material comprises an inclined surface protruding from the inspection target and inclined in a direction intersecting a display direction, and
wherein the target position is on the inclined surface.

17. The method of claim 16, wherein the determining whether the organic layer is present further comprises:
comparing the gray value extracted from the target position with a reference value; and
determining that an organic layer is present at the target position when the extracted gray value is greater than the reference value.

18. The method of claim 17, wherein the determining whether the organic layer is present further comprises determining that the inspection target is defective when the target position, where the organic layer is determined to be present, is located farther from the display area than a reference position.

19. The method of claim 17, wherein the determining whether the organic layer is present further comprises defining that no organic layer is present in regions adjacent to the organic layer inspection region and not captured by the camera when the target position is determined to have no organic layer present therein.

20. The method of claim 14, wherein the determining whether the organic layer is present is performed substantially simultaneously with the placing the light source and the camera together on the organic layer inspection region.
